(19) United States
(12) Patent Application Publication
(10) Pub. No.: US 2012/0285073 A1
(43) Pub. Date: Nov. 15, 2012

(54) FISH ATTRACTORS

(76) Inventor: Dale Ott, Portland, OR (US)

(21) Appl. No.: 13/107,096

(22) Filed: May 13, 2011

(51) Int. Cl. A01K 85/01; A01K 91/04

(52) U.S. Cl. 43/42.34; 43/43.1

(57) ABSTRACT

Fish attractors including a leading end, a trailing end opposite the leading end, a body extending between the leading end and the trailing end, and a fin projecting from the body proximate the trailing end. In some examples the body has a black exterior color. In certain examples the body is composed of acrylonitrile butadiene styrene. In some examples the body includes a major face that defines a surface topography that interacts with water flowing past the first major face.

### BACKGROUND

The present disclosure relates generally to fish attractors. In particular, fish attractors with exterior features selected to mimic fish prey and/or to disguise manmade fishing components are described herein.

Fish attractors are also commonly referred to as spinners or flashers and serve to attract fish to a baited hook when fishing from a moving boat. In operation, a fish attractor is attached to a fishing line and to a baited hook. The entire assembly is dragged behind the boat underwater to simulate a prey fish swimming through the water or to otherwise attract the attention of fish targeted by the fisherman.

Known fish attractors are not entirely satisfactory for the range of applications in which they are employed. For example, existing fish attractors do not satisfactorily mimic the prey that fish hunt and eat. In particular, conventional fish attractors are typically clear and do not present an exterior color that fish respond to as a food source.

Conventional fish attractors further do not have an exterior color selected to attract fish for reasons beyond mimicking prey fish. For example, conventional fish attractors do not include bright colors that are visually noticeable underwater and that invoke fish's natural curiosity.

In addition, conventional fish attractors are made from materials that are unsatisfactorily thick and heavy while also being insufficiently durable. Thick and heavy fish attractors designed to spin in the water tend to spin slowly, noisily, and unnaturally. Because of the poor movement qualities of conventional fish attractors, which draws attention to the fact that they are manmade, fish are more reluctant to approach the fish attractor and bait.

Further, known fish attractors do not include surface treatments, such as surface textures that provide desirable fluid flow characteristics when the fish attractor moves through the water. Unnatural fluid flow characteristics spook fish and causes them to avoid baited hooks attached to conventional fish attractors.

Thus, there exists a need for fish attractors that improve upon and advance the design of known fish attractors. Examples of new and useful fish attractors relevant to the needs existing in the field are discussed below.

Disclosure addressing one or more of the identified existing needs is provided in the detailed description below. References relevant to fish attractors include U.S. Pat. Nos. D218821, D363113, 3,673,727, 3,735,522, 3,805,437, 4,041,636, 5,367,816. The complete disclosures of the above patents and patent applications are herein incorporated by reference for all purposes.

### SUMMARY

The present disclosure is directed to fish attractors including a leading end, a trailing end opposite the leading end, a body extending between the leading end and the trailing end, and a fin projecting from the body proximate the trailing end. In some examples the body has a black exterior color. In certain examples the body is composed of acrylonitrile butadiene styrene. In some examples the body includes a major face that defines a surface topography that interacts with water flowing past the first major face.

### BRIEF DESCRIPTION OF THE DRAWINGS

FIG. 1 is a perspective view of a first example of a fish attractor.

FIG. 2 is a top elevation view of the fish attractor shown in FIG. 1 depicting a first major face.

FIG. 3 is a bottom elevation view of the fish attractor shown in FIG. 1 depicting a second major face.

FIG. 4 is a rear elevation view of the fish attractor shown in FIG. 1 depicting a trailing end.

FIG. 5 is a side elevation view of the fish attractor shown in FIG. 1.

### DETAILED DESCRIPTION

The disclosed fish attractors will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various fish attractors are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

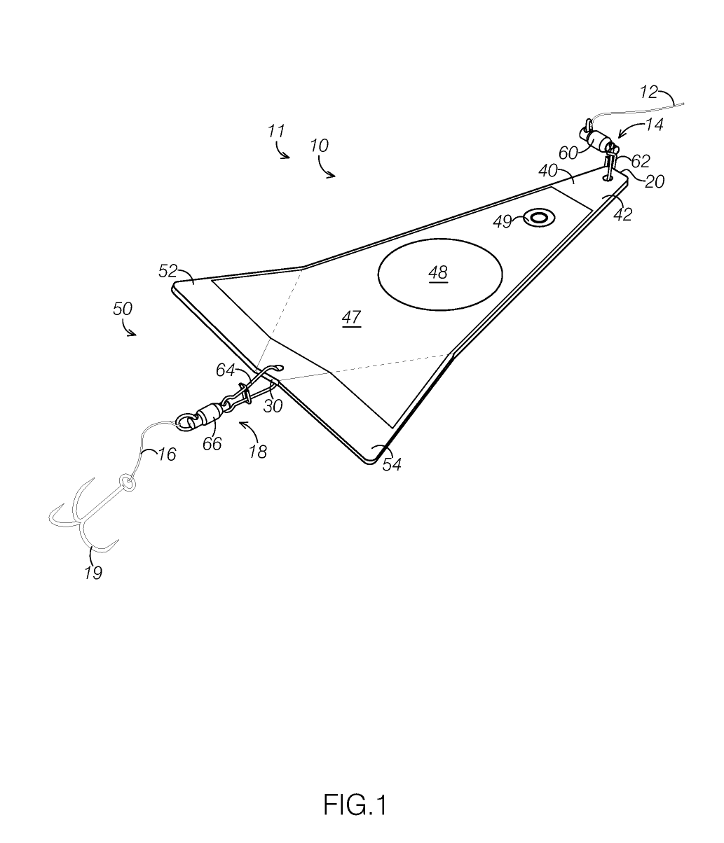

With reference to FIGS. 1-5, a fish attractor 10 (or simply attractor 10) will be described. Attractor 10 includes a leading edge 20, a trailing edge 30 opposite leading edge 20, a body 40 extending between leading end 20 and trailing end 30, and a fin 50 projecting from body 40 proximate trailing end 30. A fish attractor assembly 11 is defined as the combination of fish attractor 10, a leading line 12, a leading coupler 14, a trailing line 16, a trailing coupler 18, and a hook 19

In the example shown in FIGS. 1-3, attractor 10 is attached to leading line 12 via leading coupler 14 at leading edge 20. Fish attractor 10 is further attached to trailing line 16 via trailing coupler 18 at trailing end 30. Trailing line 16 secures hook 19, which may be baited to attract fish. The leading and trailing couplers are optional features. Indeed, in some examples the leading line couples directly to the leading end of the fish attractor and/or the trailing line couples directly to the trailing end of the fish attractor.

In the example shown in FIGS. 1-3, leading coupler 14 and trailing coupler 18 are configured to swivel about a longitudinal axis extending substantially in line with the fishing lines to which they are respectively coupled. While couplers configured to swivel are optional features, they can be advantageously employed in fish attractor assemblies described herein because they enable fish attractor 10 to swivel without twisting leading line 12 or trailing line 16. Any known type of swiveling coupler that is suitable for use underwater or that may be adapted for underwater use may be selected.

To highlight one particular type of coupler configured to swivel, leading coupler 14 and trailing coupler 18 will be explained in more detail. In the specific example shown in FIGS. 1-3, leading coupler 14 includes a leading swivel 60 coupled to a leading clasp or snap 62. Similarly, trailing coupler 18 includes a trailing clasp or snap 64 coupled to a trailing swivel 66. Leading swivel 60 and trailing swivel 66 each include a ball bearing to facilitate swiveling.

In the example shown in FIGS. 1-3, leading clasp 62 and trailing clasp 64 are configured to selectively open and close by a user manipulating a sliding ring. However, in other examples the clasps are configured to remain permanently or semi-permanently closed.

Leading clasp 62 and trailing clasp 64 maintain fixed rotational positions relative to fish attractor 10. In contrast, leading swivel 60 and trailing swivel 66 are configured to rotate freely relative to fish attractor 10 and to leading line 12 and trailing line 16, respectively. Expressed another way, fish attractor 10 may rotate freely while leading line 12 and trailing line 16 do not rotate, i.e., do not twist. As can be seen in FIGS. 1-3, leading swivel 60 is further coupled to leading line 12 and leading clasp 62 is further coupled to leading end 20. In a similar manner, trailing swivel 66 is additionally coupled to trailing line 16 and trailing clasp 64 is further selectively coupled to trailing end 30.

In operation, fish attractor assembly 11 simulates a prey fish swimming through the water or otherwise attracts the attention of fish targeted by the fisherman when pulled underwater behind a boat. Pulling fish attractor 10 through the water causes it to rotate about its longitudinal axis due to fluid mechanic interactions between the water and fin 50. The combination of fish attractor 10 rotating and translating through the water, particularly in conjunction with the novel features of fish attractor 10, has been observed to be effective at attracting the attention and interest of fish.

As shown in FIGS. 1-5, body 40 extends between leading end 20 and trailing end 30 and includes a first major face 42 and a second major face 44. In the example shown in FIGS. 1-5, body 40 is substantially planar, with first major face 42 and second major face 44 being relatively large compared to the thickness of body 40. However, the body need not be substantially planar in all examples and performs acceptably in a variety of more three-dimensional shapes.

With reference to FIGS. 1-3, the reader can see that body 40 has a shape generally in the form of an arrowhead or a triangle. The arrowhead or triangular shape of body 40 has been observed to be favorable from a fluid mechanic standpoint, but other shapes perform favorably as well. For example, the major faces may have a rectangular, square, oval, trapezoidal, circular, or irregular shape and perform well.

In the example shown in FIGS. 1-5, body 40 has a dark exterior color. In particular, body 40 has a black exterior color. In other examples, the body has one or more of the following exterior colors in a relatively dark shade: black, navy, red, magenta, blue, brown green, purple, and gray. A dark color as used herein means a color a shade of a given color that absorbs light to a higher degree that other colors or shades of a given color.

Unexpectedly, the inventor has observed that a body with a dark exterior color, in particular a black exterior color, has a marked impact on how effective the fish attractor attracts fish. When experimenting in the field with fish attractors having different exterior colors, for example black versus clear bodies, the inventor noticed that fish significantly preferred the black fish attractor. The fish's preference for the dark colored fish attractors was consistent and substantial.

After considering further this discovered correlation between dark colored fish attractors and increased fish interest, the inventor has deduced that a dark colored fish attractor may be so effective because fish perceive dark colors, in particular black, as a food source. In nature, fish prey on dark colored leaches, worms, other fish, and the like. Many of these prey species are dark colored or black. Thus, fish may more readily perceive a dark colored fish attractor as a food source.

The improved effectiveness of black and other dark colored exterior body colors is a surprising and unexpected result in the fishing accessory industry because black was thought to be a poor color choice for attracting fish. This mistaken belief was likely borne from the fact that it can be hard for humans to see a black object or other darkly colored objects underwater. Prevailing wisdom among fisherman and within the fishing industry is that fish attractors should strive to be as flashy as possible. Indeed, “flashers” are a name commonly used to describe fish attractors among fishermen and within the fishing accessory industry. Dark colored fish attractors have been mistakenly perceived as inapposite to attracting fish.

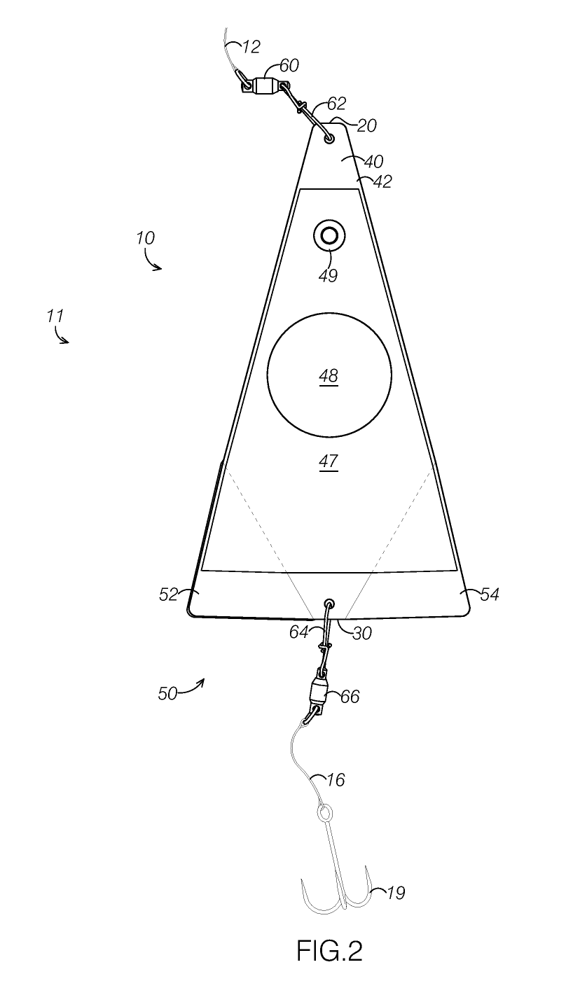

As the reader can see in FIGS. 1 and 2, body 40 includes optional visual elements, namely, first visual element 47, second visual element 48, and third visual element 49. The visual elements may be a wide variety of visually distinct and/or “flashy” features and may be attached to the body in any suitable manner, including adhesively and mechanically. The visual elements may be one or more of the following characteristics: bright, colorful, patterned, and/or reflective. As apparent from FIGS. 1 and 2, the visual elements may adopt a wide variety of shapes, with triangular and circular shapes being shown expressly in the figures. In many examples, the visual elements are selected to coordinate with and complement the attractive or prey mimicking qualities of the base exterior color.

In the example shown in FIGS. 1-5, body 40 is composed of a plastic material. In particular, body 40 is composed of acrylonitrile butadiene styrene, sometimes referred to as ABS plastic. Through development and observation, the inventor has learned that acrylonitrile butadiene styrene provides an excellent strength to weight ratio, allows the body to be advantageously thin without significant risk of breaking, and provides a lighter fish attractor, which makes the fish attractor more maneuverable in the water. While body 40 is composed of a specific plastic material, a wide variety of other plastic materials are also suitable, including polycarbonate and high impact styrene. Materials beyond plastic are suitable as well, including metals, wood, foams, open cell materials, and composite materials.

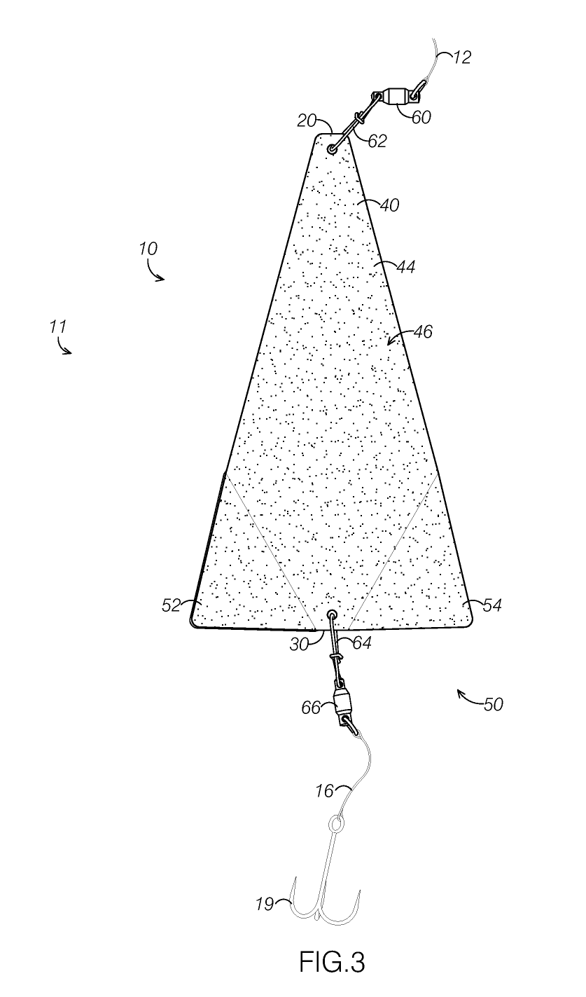

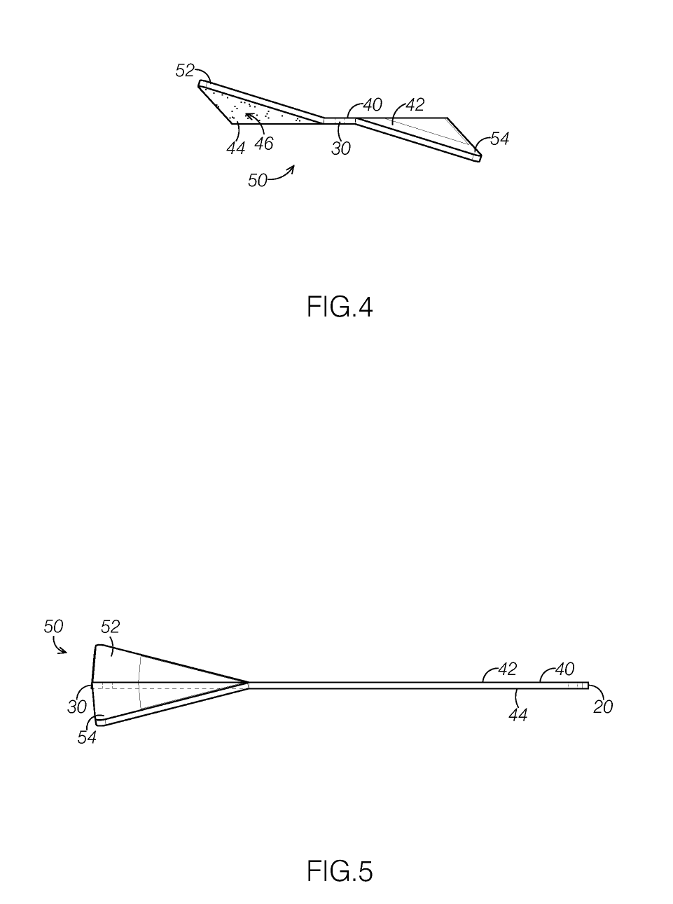

As can be seen in FIGS. 3 and 4, second major face 44 defines a surface topography or texture 46 that interacts with water flowing past the second major face. In the example shown in FIGS. 1-5, first major face 42 does not include a surface topography or texture, but rather is smooth. However, in other examples both the first major face and the second major face include surface topographies or textures and in other examples neither the first major face nor the second major face include surface topographies or textures. In still other examples, one or both of the first major face and the second major face define different regions, where the different regions have different textures and/or where some regions are smooth and others have a texture.

In the example shown in FIGS. 1-5, second major face 44 defines a horse hair texture. Any surface texture suitable for interacting with water flowing past the textured face may be used, such as textures including bristles, scales, longitudinal aligned ridges, laterally aligned ridges, combinations of lateral and longitudinal ridges, pebbles, depressions, swirls, and the like. The fluid mechanics of water flowing past the textured face can be advantageously adjusted based on the characteristics of the texture, including the type of texture, the height of the texture, the density of the texture, etc. For example, those skilled in the art will understand that the flow of water past the textured surface can be made more turbulent or laminar depending on the properties of the surface texture.

When the surface texture is selected to make the water flow characteristics more turbulent, the resulting eddies and bubbles cause the fish attractor to be more frothy as it move through the water. The froth, vibrations, and general fluid disruption resulting from the turbulent flow characteristics may attract more attention and interest from fish. Given the complexity of fluid mechanic dynamics, sometimes turbulent flow will make the fish attractor move more silently or responsively through the water.

When the surface texture is selected to make the water flow characteristics more laminar, the resulting smooth flow of water past the fish attractor may more closely mimic slow moving, vulnerable to attack prey. Mimicking the movement characteristics of a fish prey may make a target fish more likely to pursue the fish attractor and “hit” the baited hook.

Shown perhaps most clearly in FIGS. 1, 4 and 5, fin 50 projects from body 40 proximate trailing end 30 at an angle relative to the plane defined by body 40. Fin 50 interacts with the water flowing past fish attractor 10 to rotate fish attractor 10. In particular, fin 50 serves as a vane causing fish attractor 10 to rotate about its central longitudinal axis when acted on by water flowing against fin 50.

In the specific example shown in FIGS. 1-5, fin 50 includes a first fin 52 and a second fin 54 laterally opposite first fin 52. With reference to FIGS. 1, 4, and 5, first fin 52 projects from body 40 at an acute angle relative to first major face 42 and second fin 54 projects from body 40 at an acute angle relative to second major face 44. In the particular example shown in FIGS. 1-5, first fin 52 and second fin 54 project from their respective major faces at an identical acute angle, but in other examples they project at different angles. The projection angles are selected to impart desired movement characteristics underwater, including a desired rotation rate and a desired degree of lateral translation or lack thereof.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A fish attractor, comprising:
a leading end,
a trailing end opposite the leading end,
a body extending between the leading end and the trailing end, the body having a black exterior color; and
a fin projecting from the body proximate the trailing end.

2. The fish attractor of claim 1, wherein the body is substantially planar and the fin projects from the body at an angle relative to the plane defined by the body.

3. The fish attractor of claim 1, further comprising a coupler operatively connected to the leading end of the body and to a fishing line, the coupler being configured to swivel about a longitudinal axis extending substantially in line with the fishing line.

4. The fish attractor of claim 3, wherein the coupler includes a ball bearing.

5. The fish attractor of claim 3, wherein the coupler defines a first coupler and the fish attractor comprises a second coupler operatively connected to the trailing end and to a trailing line securing a fishing hook, the second coupler being configured to swivel about a longitudinal axes extending substantially in line with the trailing line.

6. The fish attractor of claim 1, wherein the body is composed of a plastic material.

7. The fish attractor of claim 6, wherein the body is composed of acrylonitrile butadiene styrene.

8. The fish attractor of claim 1, wherein:
the body includes a first major face and a second major face opposite the first major face; and
at least the second major face defines a surface topography that interacts with water flowing past the second major face.

9. The fish attractor of claim 1, wherein the body defines a substantially arrowhead shape.

10. The fish attractor of claim 1, wherein the fin defines a first fin and the fish attractor further comprises a second fin projecting from the body proximate the trailing end and laterally opposite the first fin.

11. The fish attractor of claim 10, wherein:
the body is substantially planar and includes a first major face and a second major face opposite the first major face;
the first fin projects from the body at an acute angle relative to the first major face; and
the second fin projects from the body an acute angle relative to the second major face.

12. A fish attractor, comprising:
a leading end,
a trailing end opposite the leading end,
a body composed of acrylonitrile butadiene styrene extending between the leading end and the trailing end; and
a fin projecting from the body proximate the trailing end.

13. The fish attractor of claim 12, wherein the body has a dark exterior color.

14. The fish attractor of claim 13, wherein the body has a black exterior color.

15. The fish attractor of claim 12, wherein:
the body includes a first major face and a second major face opposite the first major face; and
the second major face defines a surface topography that interacts with water flowing past the second major face.

16. The fish attractor of claim 12, wherein:
the fin defines a first fin and the fish attractor further comprises a second fin projecting from the body proximate the trailing end and laterally opposite the first fin.
the body is substantially planar and includes a first major face and a second major face opposite the first major face;
the first fin projects from the body at an acute angle relative to the first major face; and
the second fin projects from the body an acute angle relative to the second major face.

17. The fish attractor of claim 12, further comprising:
a first coupler operatively connected to the leading end of the body and to a fishing line, the coupler being configured to swivel about a longitudinal axis extending substantially in line with the fishing line; and
a second coupler operatively connected to the trailing end and to a trailing line securing a fishing hook, the second coupler being configured to swivel about a longitudinal axes extending substantially in line with the trailing line.

18. A fish attractor, comprising:
a leading end,
a trailing end opposite the leading end,
a substantially planar body extending between the leading end and the trailing end, the body including:
a first major face, and
a second major face opposite the first major face, the second major face defining a surface topography that interacts with water flowing past the second major face;
a first fin that projects from the body proximate the trailing end at an acute angle relative to the first major face; and
a second fin laterally opposite the first fin, the second fin projecting from the body proximate the trailing end at an acute angle relative to the second major face.

19. The fish attractor of claim 0, wherein the body has a dark exterior color.

20. The fish attractor of claim 0, wherein the body is composed of acrylonitrile butadiene styrene.
